(19) United States
(12) Patent Application Publication
(10) Pub. No.: US 2002/0034368 A1
(43) Pub. Date: Mar. 21, 2002

(54) Method to reduce frequency width of half-maximum of slanted fiber grating

(76) Inventors: Lih-Gen Sheu, Hsin-Wu Hsiang (TW); Ying-Tso Lin, Chu-Tung (TW)

Correspondence Address: J.C. Patents, Inc., Suite 114, 1340 Reynolds Ave., Irvine, CA, 92614, US

(21) Appl. No.: 09/900,254

(22) Filed: Jul. 6, 2001

(30) Foreign Application Priority Data
Sep. 15, 2000 (TW) 89118902

(51) Int. Cl. G02B 6/22

(52) U.S. Cl. 385/127

(57) ABSTRACT

A method to reduce the FWHM of a slanted fiber grating. The slanted fiber grid is fabricated within a photosensitive fiber. The photosensitive fiber has a core for transmitting optical signals, an inner cladding around the core and an outer cladding around the inner cladding. The method to reduce the FWHM of the slanted fiber grating includes increasing the refractive index and/or diameter and/or lowering the photosensitivity of the inner cladding. In addition, a null core can be inserted into the center of the photosensitive fiber surrounded by an outer core. By increasing the diameter of the null core, the FWHM of the slant fiber grating can be reduced.

### CROSS-REFERENCE TO RELATED APPLICATION

This application claims the priority benefit of Taiwan application serial no. 89118902, filed Sep. 15, 2000.

### BACKGROUND OF THE INVENTION

1. Field of Invention

The present invention relates to a slanted fiber grating. More particularly, the present invention relates to a method to reduce the frequency width of half-maximum (FWHM) of a slanted fiber grating.

2. Description of Related Art

The gain of an optical amplifier is wavelength-dependent. When lights of with different wavelengths pass through an optical amplifier, different gains are obtained. In long haul system, signals have to undergo several rounds of amplification before arriving at the destination. If during every optical amplification, a portion of the light spectrum obtains a higher gain while another portion of the light spectrum obtains a lower gain. The power ratings between the high gain signals and the low gain signals can be considerable due to cumulative effect. A number of problems may result when the signals are finally intercepted at the receiving terminal. Hence, in a wavelength-division-multiplexing (WDM) system, various optical amplifiers are designed such that the gain at each wavelength is as close to each other as possible.

There are two gain equalization methods. One method utilizes the long-period grating (LPG) to perform the necessary gain equalization. The advantages of using LPG include low cost and low insertion loss. However, the LPG is so sensitive to change in temperature and bending that the technique of special package is necessary. The other method utilizes the slanted fiber grating (SFBG) to perform gain equalization. The SFBG has all the advantages of LPG but without the disadvantages of temperature and bending sensitivity.

Nevertheless, if the slanted fiber grating is fabricated by using a conventional single-mode fiber or photosensitive fiber, the FWHM of its transmission spectrum is too wide (>15 mm) to use as a gain equalizer in an optical amplifier. Currently, the special optical fiber, which can provides the slanted fiber grating having a narrow FWHM, is not yet available. Consequently, there is an urgent demand for specialized optical fiber capable of equalizing the gain of an optical amplifier.

In an article written by M. J. Holmes et al titled “Novel Fiber Design for Narrow-Band Symmetric Response Sidetap Filters with Suppressed Leaky Mode Resonance”, an optical fiber design capable of reducing the FWHM of a slant fiber grating has been proposed. The refractive index profile is identical to a conventional step index fiber. The only difference lies in the photosensitivity between the fiber core and the fiber cladding.

### SUMMARY OF THE INVENTION

Accordingly, one object of the present invention is to provide a method for reducing the FWHM of a slanted fiber grating. The slanted fiber grating is fabricated within a photosensitive fiber. The photosensitive fiber includes a core, an inner cladding and an outer cladding. The core is used for transmitting optical signals. The inner cladding surrounds the core. The outer cladding surrounds the inner cladding. The method to reduce the FWHM of the slanted fiber grating includes increasing the refractive index of the inner cladding or increasing the diameter of the inner cladding.

This invention also provides a second method to reduce the FWHM of a slanted fiber grating. The slant fiber grating is fabricated within a photosensitive fiber. The photosensitive fiber includes a core, an inner cladding and an outer cladding. The core is used for transmitting optical signals. The inner cladding surrounds the core. The outer cladding surrounds the inner cladding. The outer cladding is not photosensitive while both the core and the inner cladding are photosensitive. The method to reduce the FWHM of the slanted fiber grating includes decreasing the photosensitivity of the core.

This invention also provides a third method to reduce the FWHM of a slanted fiber grating. The slanted fiber grating is fabricated within a photosensitive fiber. The photosensitive fiber includes a null core, an outer core, an inner cladding and an outer cladding. The outer core surrounds the null core and is the medium for transmitting optical signals. The inner cladding surrounds the outer core. The outer cladding surrounds the inner cladding. Both the null core and the outer cladding are not photosensitive while both the outer core and the inner cladding are photosensitive. The method to reduce the FWHM of the slanted fiber grating includes increasing the diameter of the null core.

In brief, this invention provides a method capable of reducing the FWHM of a slanted fiber grating that can be used as a gain equalizer in an optical amplifier.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram for illustrating the method to reduce the FWHM of a slanted fiber grating according to a first and a second embodiment of this invention;

FIG. 2 is a graph showing transmission spectra of the slanted fiber gratings with various refractive indices of the inner cladding shown in FIG. 1;

FIG. 3 is a graph showing transmission spectra of the slanted fiber gratings with various diameters of the inner cladding shown in FIG. 1;

FIG. 4 is a schematic diagram for illustrating the method to reduce the FWHM of a slanted fiber grating according to a third embodiment of this invention;

FIG. 5 is a graph showing transmission spectra of the slanted fiber gratings with various photosensitivities of core shown in FIG. 4;

FIG. 6 is a schematic diagram for illustrating the method to reduce the FWHM of a slanted fiber grating according to a fourth embodiment of this invention; and

FIG. 7 is a graph showing transmission spectra of the slanted fiber gratings with various diameters of the null core shown in FIG. 6.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

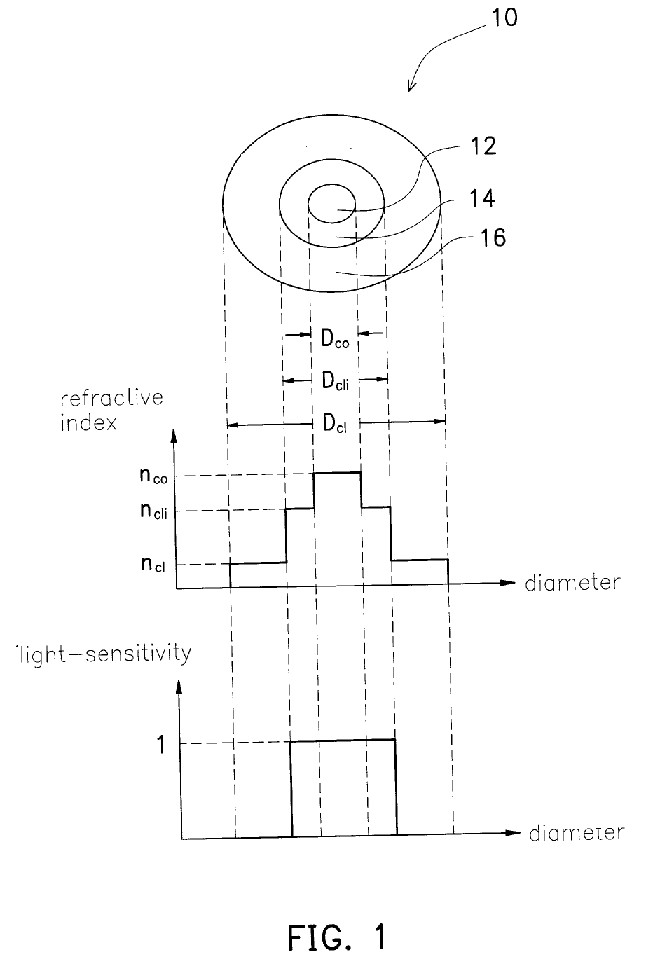

FIG. 1 is a schematic diagram for illustrating the method to reduce the FWHM of a slanted fiber grating according to a first embodiment of this invention. The slanted fiber grating of this invention is fabricated within a photosensitive fiber 10. The photosensitive fiber 10 has a core 12, an inner cladding 14 around the core 12, and an outer cladding 16 around the inner cladding 14. Symbols D_{co}, D_{cli} and D_{clo} represent the diameters of the core 12, the inner cladding 14, and the outer cladding 16 respectively. In FIG. 1, the refractive index profile and photosensitivity profile across the photosensitive fiber 10 are shown. Symbols n_{co}, n_{cli} and n_{clo} represents the refractive indices of the core 12, the inner cladding 14 and the outer cladding 16 respectively. The photosensitivity profile shows clearly that both the core 12 and the inner cladding 14 are photosensitive while the outer cladding 16 is not photosensitive.

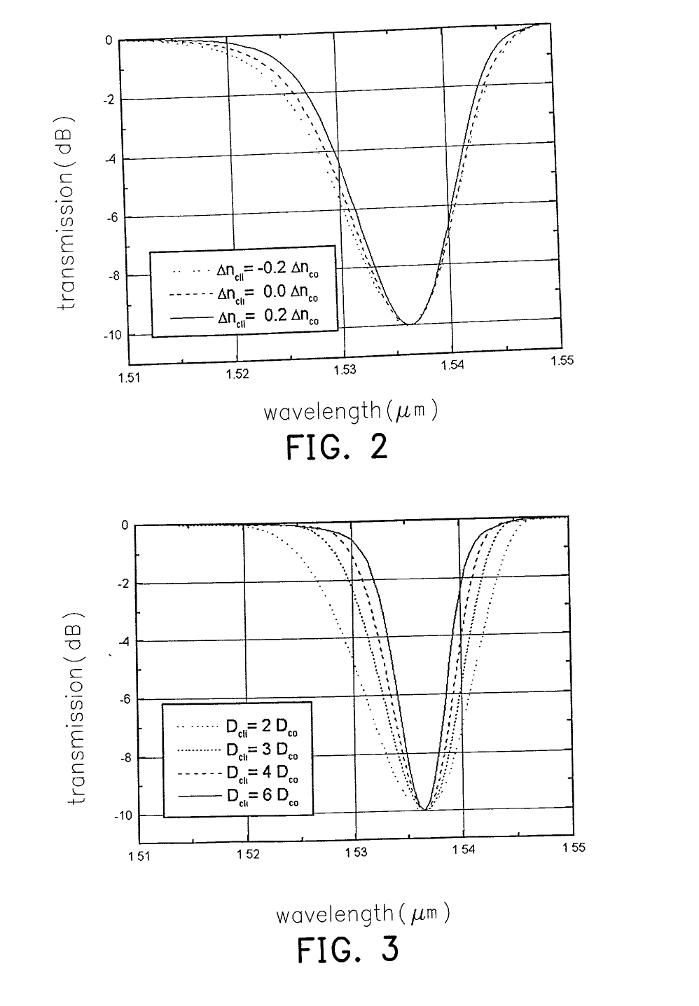

According to the first embodiment of this invention, the method to reduce the FWHM of a slanted fiber grating includes increasing the refractive index of the inner cladding 14. FIG. 2 is a graph showing transmission spectra of the slanted fiber gratings with various refractive indices of the inner cladding 14 shown in FIG. 1.

FIG. 1 is also a schematic diagram for illustrating the method to reduce the FWHM of a slanted fiber grating according to a second embodiment of this invention. According to the second embodiment of this invention, the method to reduce the FWHM of a slanted fiber grating includes increasing the diameter of the inner cladding 14. FIG. 3 is a graph showing transmission spectra of the slanted fiber gratings with various diameters of the inner cladding 14 shown in FIG. 1.

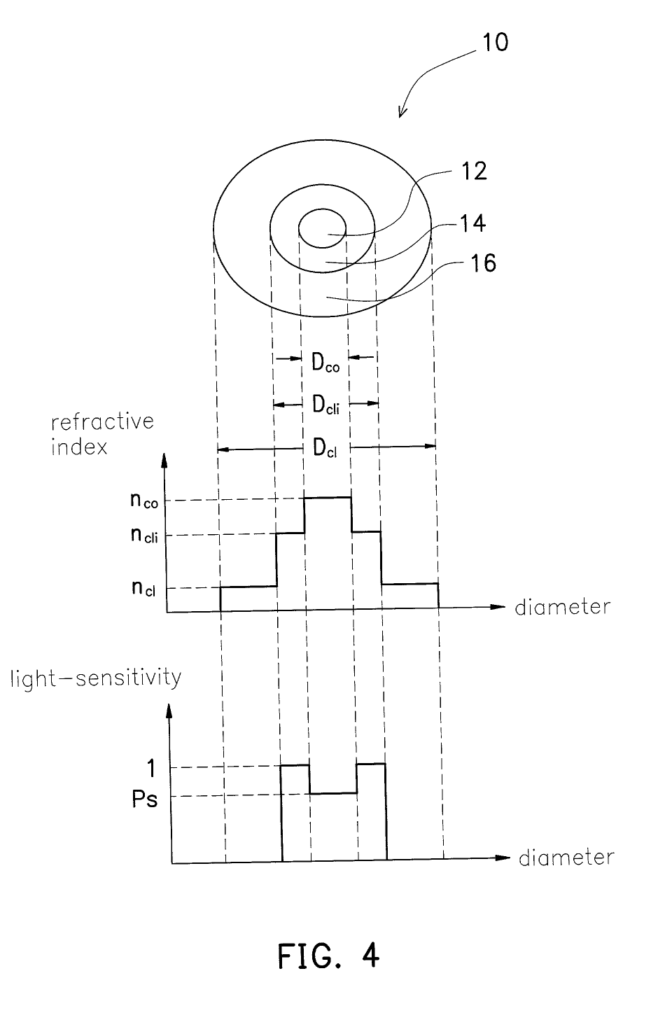

FIG. 4 is a schematic diagram for illustrating the method to reduce the FWHM of a slanted fiber grating according to a third embodiment of this invention. The slanted fiber grid of this invention is fabricated within a photosensitive fiber 10. The photosensitive fiber 10 has a core 12, an inner cladding 14 around the core 12, and an outer cladding 16 around the inner cladding 14. Symbols D_{co}, D_{cli} and D_{clo} represent the diameters of the core 12, the inner cladding 14, and the outer cladding 16 respectively. In FIG. 4, the refractive index profile and photosensitivity profile across the photosensitive fiber 10 are shown. Symbols n_{co}, n_{cli} and n_{clo} represents the refractive indices of the core 12, the inner cladding 14, and the outer cladding 16 respectively. The photosensitivity profile shows clearly that both the core 12 and the inner cladding 14 are photosensitive while the outer cladding 16 is not photosensitive.

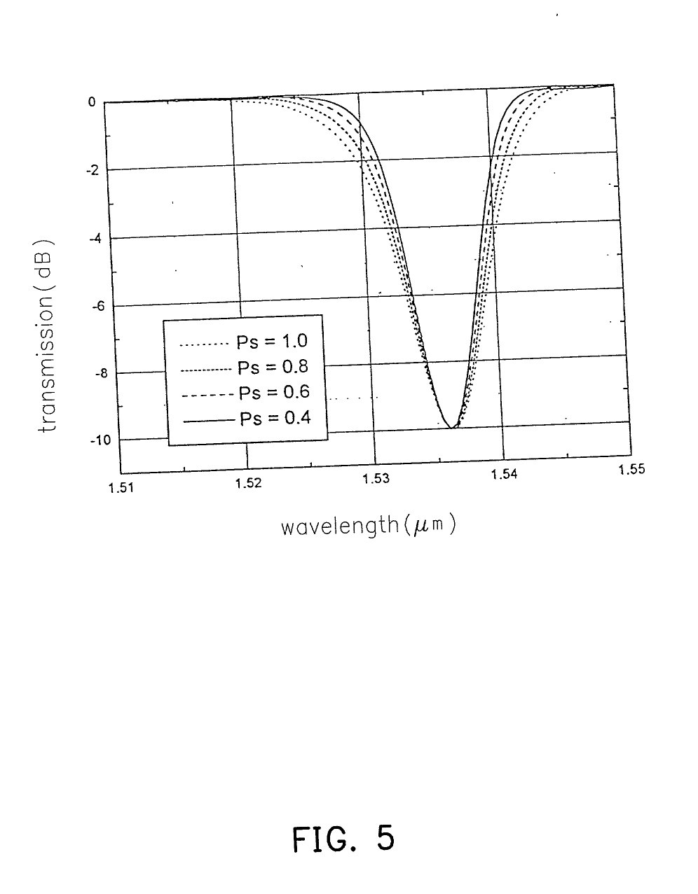

According to the third embodiment of this invention, the method to reduce the FWHM of a slanted fiber grating includes decreasing the photosensitivity of the core 12. FIG. 5 is a graph showing transmission spectra of the slanted fiber gratings with various photosensitivities of core shown in FIG. 4. In the aforementioned method, the FWHM of a slanted fiber grating can be further reduced by increasing the refractive index or the inner cladding 14 or increasing the diameter of the inner cladding 14.

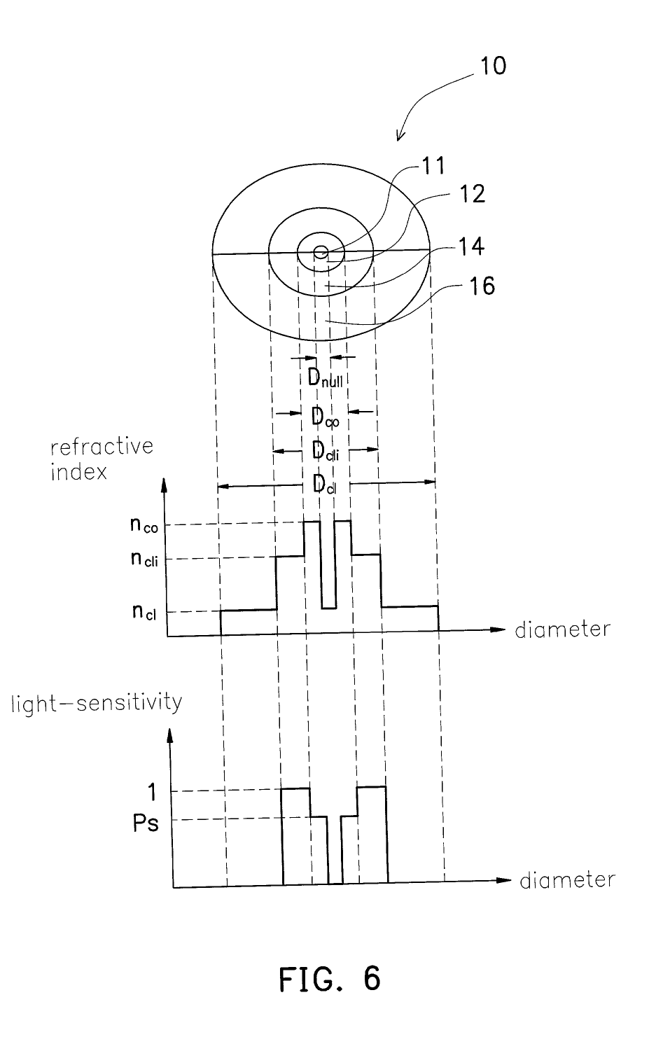

FIG. 6 is a schematic diagram for illustrating the method to reduce the FWHM of a slanted fiber grating according to a fourth embodiment of this invention. The slanted fiber grating is fabricated within a photosensitive fiber 10. The photosensitive fiber 10 has a null core 11, an outer core 12 around the null core 11, an inner cladding 14 around the outer core 12, and an outer cladding 16 around the inner cladding 14. Symbols Dₙᵤₗₗ, D_{oco} D_{cli} and D_{clo} represent the diameters of the null core 11, the outer core 12, the inner cladding 14, and the outer cladding 16 respectively. In FIG. 6, the refractive index profile and photosensitivity profile across the photosensitive fiber 10 are shown. Symbols nuₙᵤₗₗ, n_{oco}, n_{cli} and n_{clo} represents the refractive indices of the core 12, the inner cladding 14, and the outer cladding 16 respectively. The photosensitivity profile shows clearly that both the outer core 12 and the inner cladding 14 are photosensitive while the null core and the outer cladding 16 are not photosensitive.

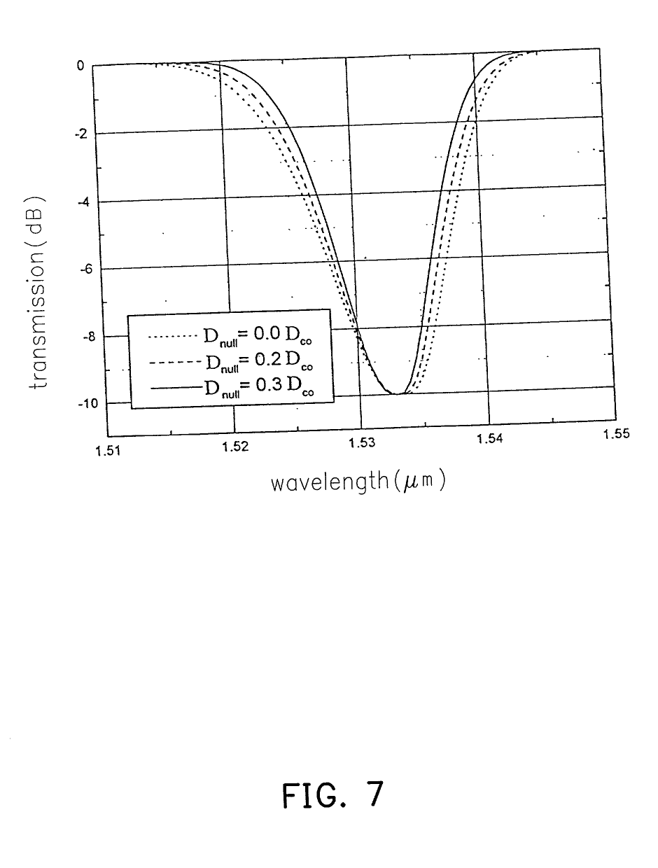

According to the fourth embodiment of this invention, the method to reduce the FWHM of a slanted fiber grating includes increasing the diameter of the null core 11. FIG. 7 is a graph showing transmission spectra of the slanted fiber gratings with various diameters of the null core shown in FIG. 6. In addition, the FWHM of a slanted fiber grating can be further reduced by lowering the photosensitivity of the outer core 12.

In summary, this invention provides a method capable of reducing the FWHM of a slanted fiber grating that serves as a gain equalizer for an optical amplifier.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method to reduce the FWHM of a slanted fiber grating is that the said slanted fiber grating is fabricated within a photosensitive fiber, having a core for transmitting optical signals, an inner cladding around the core, and an outer cladding around the inner cladding, comprising the step of:
increasing the refractive index of the inner cladding.

2. The method of claim 1, wherein the FWHM of the slant fiber grating is further reduced by increasing the diameter of the inner cladding.

3. A method to reduce the FWHM of a slanted fiber grating is that the said slanted fiber grating is fabricated within a photosensitive fiber, having a core for transmitting optical signals, an inner cladding around the core, and an outer cladding around the inner cladding, comprising the step of:
increasing the diameter of the inner cladding.

4. A method to reduce the FWHM of a slanted fiber grating is that the said slanted fiber grating is fabricated within a photosensitive fiber, having a core for transmitting optical signals, an inner cladding around the core, and an outer cladding around the inner cladding; the said outer cladding is not photosensitive while the core and the inner cladding are photosensitive, comprising the step of:
lowering the photosensitivity of the core.

5. The method of claim 4, wherein the FWHM of the slant fiber grating is further reduced by increasing the refractive index of the inner cladding.

6. The method of claim 4, wherein the FWHM of the slant fiber grating is further reduced by increasing the diameter of the inner cladding.

7. The method of claim 5, wherein the FWHM of the slant fiber grating is further reduced by increasing the diameter of the inner cladding.

8. A method to reduce the FWHM of a slanted fiber grating is that the said slanted fiber grating is fabricated within a photosensitive fiber, having a null core, an outer core around the null core for transmitting optical signals, an inner cladding around the outer core, and an outer cladding around the inner cladding, the null core and the outer cladding are not light sensitive while the outer core and the inner cladding are light sensitive, comprising the step of:
increasing the diameter of the null core.

9. The method of claim 8, wherein the FWHM of the slant fiber grating is further reduced by lowering the photosensitivity of the outer core.
